(19) United States
(12) Patent Application Publication
(10) Pub. No.: US 2009/0282460 A1
(43) Pub. Date: Nov. 12, 2009

(54) System and Method for Transferring Information Through a Trusted Network

(75) Inventor: Randall S. Brooks, Apollo Beach, FL (US)

Correspondence Address: BAKER BOTTS LLP, 2001 ROSS AVENUE, 6TH FLOOR, DALLAS, TX, 75201-2980, US

(73) Assignee: Raytheon Company, Waltham, MA (US)

(21) Appl. No.: 12/463,746

(22) Filed: May 11, 2009

Related U.S. Application Data
(60) Provisional application No. 61/052,539, filed on May 12, 2008.

(51) Int. Cl. G06F 21/00; H04L 12/56; G06F 15/16

(52) U.S. Cl. 726/1; 709/228; 370/389

(57) ABSTRACT

A networking method includes receiving a first data packet from a computing node at a middleware process of a first computing system, adding, by the middleware process, a Common Internet Protocol Security Option (CIPSO) label to the data packet to form a modified packet, and transmitting, by a separation kernel, the modified packet to a second computing system. The first computing system includes an embedded operating system, and the computing node is coupled to the first computing system. The second computing system includes a CIPSO compliant operating system.

### CROSS-REFERENCE TO RELATED APPLICATION

This application claims the benefit of priority under 35 U.S.C. §119(e) of U.S. Provisional Application Ser. No. 61/052,539, entitled “System for Transferring Information Through a Trusted Network”, filed May 12, 2008.

### TECHNICAL FIELD

This disclosure relates generally to the field of networking, and more particularly, to a system and method for transferring information through a trusted network.

### BACKGROUND

Many government, public, and private entities have multiple security classification levels for data. As a result, many entities desire to secure their data by prohibiting the exchange and mixing of data having different security classification levels. To accomplish this, may entities employ Multiple Independent Levels of Security (MILS) systems.

### SUMMARY OF THE DISCLOSURE

According to one embodiment of the present disclosure, a networking method includes receiving a first data packet from a computing node at a middleware process of a first computing system, adding, by the middleware process, a Common Internet Protocol Security Option (CIPSO) label to the data packet to form a modified packet, and transmitting, by a separation kernel, the modified packet to a second computing system. The first computing system includes an embedded operating system, and the computing node is coupled to the first computing system. The second computing system includes a CIPSO compliant operating system.

Certain embodiments of the disclosure may provide one or more technical advantages. A technical advantage of one embodiment may be that a Multiple Independent Levels of Security (MILS) system may communicate with a trusted computing system that a human man interact with by using Commercial Internet Protocol Security Option (CIPSO) labels.

Certain embodiments of the disclosure may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present disclosure and its features and advantages, reference is now made to the following description, taken in conjunction with the accompanying drawings, in which:

FIG. 1 is a block diagram illustrating a system that may be utilized to transfer information through a trusted network in accordance with a particular embodiment of this disclosure;

FIG. 2 is a block diagram illustrating a system in accordance with a particular embodiment of this disclosure that may be utilized by the system in FIG. 1 to transfer information through a trusted network;

FIG. 3 is a flow chart illustrating a method that may be utilized by MILS CIPSO middleware 150 in FIG. 2 in accordance with a particular embodiment of this disclosure; and

FIG. 4 is a flow chart illustrating another method that may be utilized by MILS CIPSO middleware 150 in FIG. 2 in accordance with a particular embodiment of this disclosure.

### DETAILED DESCRIPTION OF THE DRAWINGS

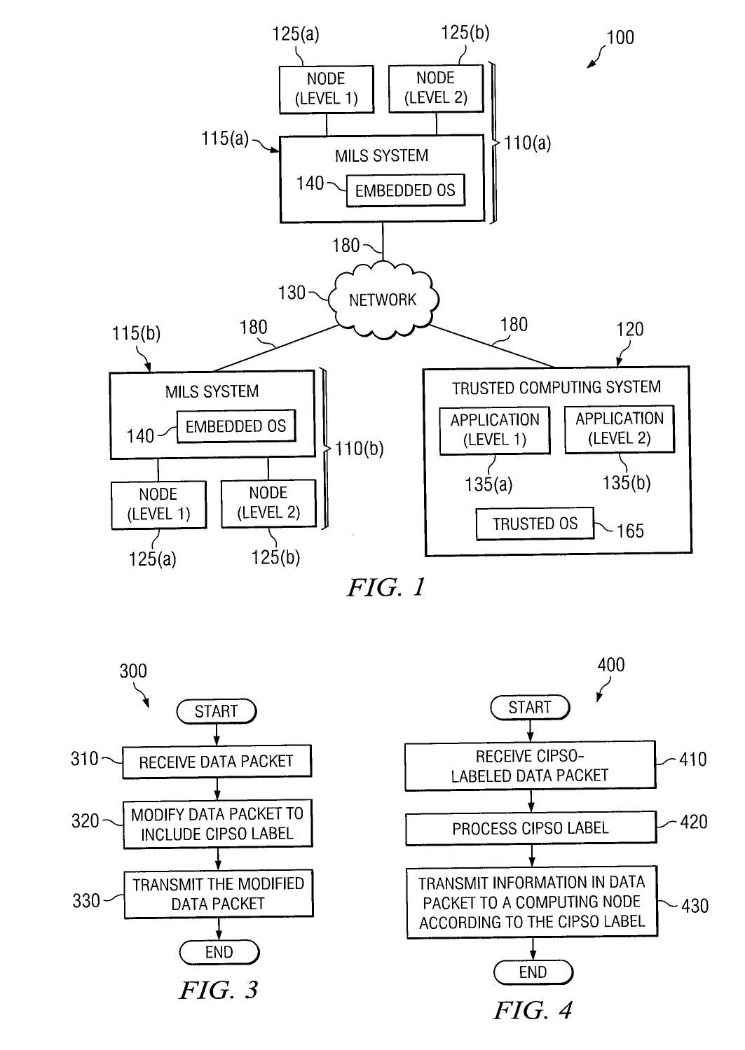

Embodiments of the present disclosure and its advantages are best understood by referring to FIGS. 1 through 4 of the drawings, like numerals being used for like and corresponding parts of the various drawings.

Multiple Independent Levels of Security (MILS) systems are computing systems that are utilized to process and direct the flow of data having different security classification levels. In some cases, MILS systems may be implemented on a single system by employing a separation kernel and/or a middleware process in an embedded operating system to separate applications operating at different classification levels. Such systems typically, however, are configured to only communicate with other embedded operating systems. As a result, these systems are unable to communicate with a trusted computing system that is accessible to a human.

The teachings of the disclosure recognize that it would be desirable to provide communications between a MILS system and a trusted computer system that is accessible to a human. FIGS. 1 through 4 below illustrate a system and method for transferring information through a trusted network according to the teachings of the disclosure.

FIG. 1 illustrates a trusted networking system 100. In the illustrated embodiment, system 100 includes MILS networks 110(a) and 110(b), a trusted computing system 120, and a trusted network 130. MILS networks 110 include computing nodes 125 and MILS computing systems 115 running an embedded operating system (OS) 140. MILS computing systems 115 and trusted computing system 120 may include memory and a processor (not shown). Trusted computing system 120 includes applications 135 and a trusted OS 165. MILS networks 110 and trusted computing system 120 are communicatively coupled to trusted network 130 via a network connection 180.

Computing nodes 125 and applications 135 may be associated with different data classification levels. For example, computing nodes 125(a) and application 135(a) may be associated with a classification level 1, and computing nodes 125(b) and application 135(b) may be associated with a classification level 2. The classification levels may be, for example, “unclassified”, “confidential”, “secret”, “top secret”, and the like.

Trusted computing system 120 refers to any computer and/or computing system that is capable of isolating data packets having different data classification levels. Trusted computing system 120 includes trusted OS 165 that is capable of transmitting data having different data classification levels to computer processes and/or applications associated with a corresponding classification level. Trusted OS 165 may be any CIPSO compliant operating system such as Sun Microsystem's Solaris with Trusted Extensions, SGI's Trusted IRIX, Security-Enhanced Linux, and the like.

In operation, MILS computing systems 115 provide data processing and routing functions for computing nodes 125 that are associated with different classification levels. For example, MILS computing system 115(a) receives data having a classification level of “1” from computing node 125(a) and routes it over network connection 180 to trusted network 130. The data may travel to MILS computing system 115(a) where it may be distributed to a computing node 125 that also has a classification level of “1”. Additionally, MILS computing system 115(a) may receive data having a classification level of “1” from trusted network 130 and route it to computing node 125(a). As a result, MILS computing systems 115 prohibit the exchange and mixing of data having different classification levels.

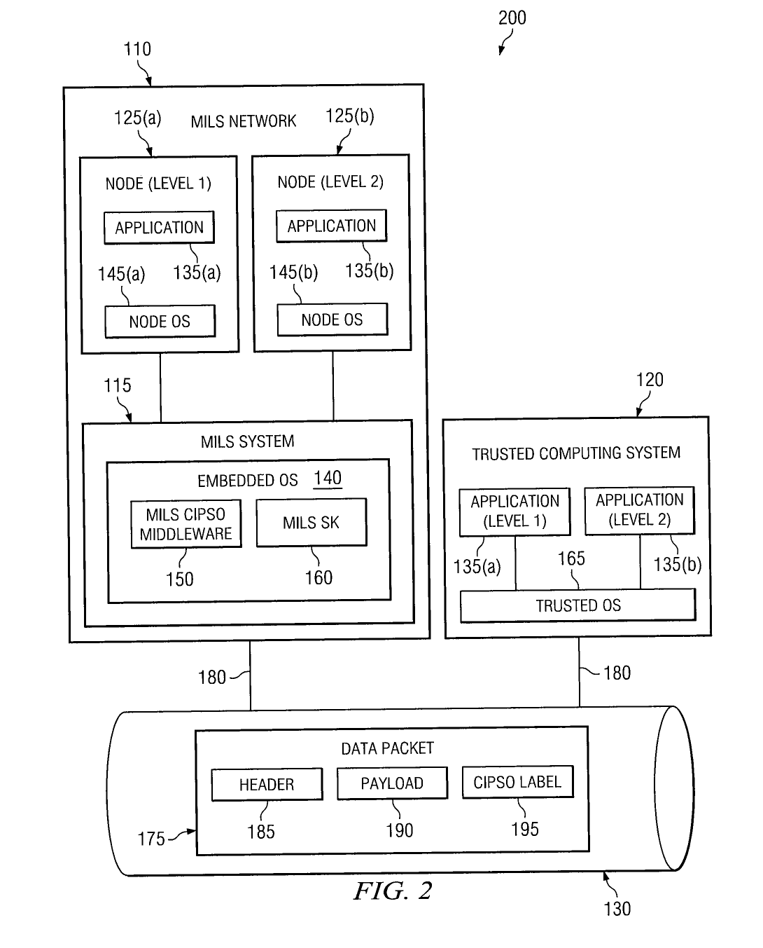

Typically, MILS systems have only one network connection and thus are limited to transmitting and receiving data having different classification levels to/from other embedded operating systems. For example, MILS computing system 115(a) having a single network connection 180 would typically be capable of exchanging data only with MILS computing system 115(b), but not with trusted computing system 120. FIGS. 2 and 3 below, however, illustrate how MILS computing systems 115 may communicate with trusted computing system 120 through a single network connection 180 by utilizing Common Internet Protocol Security Option (CIPSO) labels.

FIG. 2 illustrates an embodiment of a system 200 that may be used to provide communications between MILS network 110 and trusted computing system 120 using CIPSO labels. System 200 includes MILS network 110, trusted computing system 120, and trusted network 130. MILS network 110 and trusted computing system 120 are communicatively coupled to trusted network 130 via a network connection 180. MILS network 110 and trusted computing system 120 exchange data packets 175 that include a header 185, a payload 190, and CIPSO label 195.

MILS network 110 includes MILS computing system 115 having embedded OS 140. Embedded OS 140 may be any embedded operating system capable of handling MILS functions. Embedded OS 140 further includes a MILS CIPSO middleware 150 and a MILS separation kernel (SK) 160. As will be described in detail below, MILS CIPSO middleware 150 provides secure communications between computing nodes 125 and trusted computing system 120 by attaching CIPSO labels 195 to data packets 175 that are transmitted from computing nodes 125, and filtering CIPSO-labeled data packets 175 transmitted from trusted computing system 120.

MILS CIPSO middleware 150 and MILS SK 160 may be computer processes and may include executable instructions stored in memory and executed on a suitable computing system. For example, MILS CIPSO middleware 150 and MILS SK 160 may be stored in memory (not shown) located in and/or accessible to MILS computing system 115, and may be executed by a processor (not shown) in MILS computing system 115. MILS CIPSO middleware 150 may modify or generate any type of data packet, such as a data packet conforming to an Internet protocol version 4 (IPv4) protocol, an Internet protocol version 6 (IPv6) protocol, and the like. MILS SK 160 may refer to any suitable separation kernel known in the art.

MILS network 110 additionally includes one or more computing nodes 125. Computing nodes 125 include application 135 and a node OS 145. Each of nodes OS 145 may be any operating system that is capable of communicating with a MILS computing system.

As described above, computing nodes 125 may be associated with different data classification levels. In the illustrated embodiment, for example, computing node 125(a) may be associated with a classification level 1 and computing node 125(b) may be associated with a classification level 2.

In general, trusted network 130 is any network capable of transporting data packets 175 having CIPSO labels. Trusted network 130 may include at least a portion of a public or private data network, a LAN, a MAN, a WAN, a local, regional, or global communication or computer network such as the Internet, a wireline or wireless network, an enterprise intranet, other suitable communication link, or any combination of the preceding.

In operation, MILS system 115 provides communications between computing nodes 125 and trusted computing system 120 using data packets 175 having CIPSO labels 195. To transmit a packet of information from computing nodes 125 to trusted computing system 120, application 135 of computing nodes 125 creates and transmits a data packet to node operating system 145. The data packet may be any type of data packet, including, but not limited to, an IPv4 or IPv6 data packet. Node operating system 145 then places the packet on its IP networking stack and executes an associated driver to communicate with MILS CIPSO middleware 150.

MILS CIPSO middleware 150 receives the data packet from node operating system 145 and modifies the data packet to create a data packet 175 having a CIPSO label 195 that indicates the classification level of the computing nodes 125 that generated the data packet. For example, if computing node 125(a) generates the data packet, MILS CIPSO middleware 150 modifies the data packet to create a data packet 175 having a CIPSO label 195 corresponding to the level “1” classification level. In certain embodiments, MILS CIPSO middleware 150 may attach CIPSO label 195 to header 185 of data packet 175. In other embodiments, MILS CIPSO middleware 150 may attach CIPSO label 195 to another portion of data packet 175 other than header 185.

After creating data packet 175 having CIPSO label 195, MILS CIPSO middleware 150 generates a system call to MILS SK 160. MILS SK 160 communicates with MILS CIPSO middleware 150 to open a connection to trusted network 130 over network connection 180. Data packet 175 is then transmitted to trusted computing system 120 via trusted network 130.

Trusted OS 165 of trusted computing system 120 receives data packet 175 via trusted network 130. Trusted OS 165 processes data packet 175 and determines if an application 135 has sufficient authorization to receive data packet 175. For example, trusted OS 165 may process CIPSO label 195 and determine data packet 175 originated from computing node 125(a) having a security classification level 1. Trusted OS 165 may then determine that application 135(a) has a corresponding security classification level 1. Once trusted OS 165 determines that application 135 has a corresponding security classification level to that of CIPSO label 195, it may transmit information in data packet 175 to application 135.

Information transmitted from application 135 to computing nodes 125 may be accomplished by reversing the previously described process. Specifically, MILS CIPSO middleware 150 may receive a data packet 175 having a CIPSO label 195. For example, the received data packet 175 may have been originally sent by application 135(b) and thus have a CIPSO label 195 corresponding to a classification level “2”. MILS CIPSO middleware 150 may process the CIPSO label 195 and transmit information in data packet 175 to computing node 125(b) which also has a classification level “2”.

FIG. 3 illustrates a method 300 that may be used by MILS CIPSO middleware 150 to transmit data packets from MILS network 110 to trusted computing system 120 using CIPSO labels. In step 310, MILS CIPSO middleware 150 receives a data packet from a computing node 125. The data packet may be, for example, an IPv4 or IPv6 data packet. In step 320, MILS CIPSO middleware 150 modifies the received packet to create a packet 175 having a CIPSO label 195. CIPSO label 195 indicates the security classification level of the computing node 125 that transmitted the data packet. In step 330, MILS CIPSO middleware 150 transmits data packet 175 having CIPSO label 195. For example, data packet 175 may be transmitted to trusted computing system 120 via trusted network 130.

FIG. 4 illustrates a method 400 that may be used by MILS CIPSO middleware 150 to process data packets 175 received from trusted computing system 120. In step 410, MILS CIPSO middleware 150 receives data packet 175 having CIPSO label 195. For example, the received data packet 175 may have been sent from trusted computing system 120. In step 420, MILS CIPSO middleware 150 processes CIPSO label 195 of data packet 175 to determine the classification level associated with CIPSO label 195. In step 430, MILS CIPSO middleware 150 transmits information in data packet 175 to a computing node 125 that has a corresponding security classification level to what is determined in step 420.

Although the embodiments in the disclosure have been described in detail, numerous changes, substitutions, variations, alterations, and modifications may be ascertained by those skilled in the art. For example, FIG. 2 illustrates MILS network 110 having two computing nodes 125. Other embodiments, however, may include only one computing node 125 or more than two computing nodes 125. In addition, while the methods and applications disclosed herein have been described with reference to IPv4 and IPv6 data packets, certain embodiments may be configured to operate with other data packet standards. It is intended that the present disclosure encompass all such changes, substitutions, variations, alterations, and modifications as falling within the spirit and scope of the appended claims.

What is claimed is:

1. A networking system comprising:
a first network operable to transport data packets;
a trusted computing system coupled to the network and operable to isolate data packets having different classification levels, the trusted computing system comprising:
one or more applications, each application having a classification level; and
a trusted operating system;
a Multiple Independent Levels of Security (MILS) network coupled to the first network, the MILS network comprising:
one or more computing nodes, each computing node having a classification level;
an embedded operating system;
a middleware process operable to receive a first data packet from the one or more computing nodes and to add a Common Internet Protocol Security Option (CIPSO) label to the first data packet to form a modified packet, the CIPSO label indicating the classification level of the computing node that transmitted the first data packet; and
a separation kernel operable to transmit the modified packet to the trusted computing system through the first network;
wherein the trusted operating system is operable to receive the modified packet and to transmit information in the modified packet to the one or more applications according to the CIPSO label of the modified packet.

2. The networking system of claim 1 wherein the middleware process is further operable to:
receive a second data packet from the trusted computing system, the second data packet having a CIPSO label; and
transmit information in the second data packet to the one or more computing nodes according to the CIPSO label of the second data packet.

3. The networking system of claim 1 wherein the first data packet comprises a protocol that is selected from the group consisting of an Internet Protocol version 4 (IPv4) protocol, and an Internet Protocol version 6 (IPv6) protocol.

4. The networking system of claim 1 wherein the adding a CIPSO label to the first data packet to form a modified packet comprises adding the CIPSO label to a header of the first data packet.

5. The networking system of claim 1 wherein the trusted operating system comprises a Sun Solaris with Trusted Extensions operating system.

6. The networking system of claim 1 wherein the separation kernel comprises a MILS separation kernel.

7. A networking system comprising:
a network operable to transport data packets;
a first computing system coupled to the network, the first computing system comprising a Common Internet Protocol Security Option (CIPSO) compliant operating system; and
a second computing system coupled to the network, the second computing system comprising:
an embedded operating system;
one or more computing nodes, each computing node having a classification level;
a middleware process operable to receive a first data packet from the one or more computing nodes and to add a CIPSO label to the first data packet to form a modified packet; and
a separation kernel operable to transmit the modified packet to the first computing system through the network.

8. The networking system of claim 7 wherein the middleware process is further operable to:
receive a second data packet having a CIPSO label from the network; and
transmit information in the second data packet to the one or more computing nodes according to the CIPSO label of the second data packet.

9. The networking system of claim 7 wherein the first data packet comprises a protocol that is selected from the group consisting of an Internet Protocol version 4 (IPv4) protocol, and an Internet Protocol version 6 (IPv6) protocol.

10. The networking system of claim 7 wherein the adding a CIPSO label to the first data packet to form a modified packet comprises adding the CIPSO label to a header of the first data packet.

11. The networking system of claim 7 wherein the CIPSO compliant operating system comprises a Sun Solaris with Trusted Extensions operating system.

12. The networking system of claim 7 wherein the separation kernel comprises a MILS separation kernel.

13. The networking system of claim 7 wherein the embedded operating system comprises a MILS operating system.

14. A networking method comprising:
receiving a first data packet from a computing node at a middleware process of a first computing system, the first computing system comprising an embedded operating system, the computing node coupled to the first computing system;
adding, by the middleware process, a Common Internet Protocol Security Option (CIPSO) label to the data packet to form a modified packet;
transmitting, by a separation kernel, the modified packet to a second computing system comprising a CIPSO compliant operating system.

15. The networking method of claim 14 further comprising:
receiving, at the middleware process, a second data packet having a CIPSO label, the second data packet transmitted from the second computing system; and
transmitting, by the middleware process, information in the second data packet to a computing node according to the CIPSO label of the second data packet.

16. The networking method of claim 14 wherein the first data packet comprises a protocol that is selected from the group consisting of an Internet Protocol version 4 (IPv4) protocol, and an Internet Protocol version 6 (IPv6) protocol.

17. The networking method of claim 14 wherein the adding a CIPSO label to the first data packet to form a modified packet comprises adding the CIPSO label to a header of the first data packet.

18. The networking method of claim 14 wherein the CIPSO compliant operating system comprises Sun Solaris with Trusted Extensions.

19. The networking method of claim 14 wherein the separation kernel comprises a MILS separation kernel.

20. The networking method of claim 14 wherein the real-time operating system comprises a MILS system.
